(19) United States
(12) Patent Application Publication
(10) Pub. No.: US 2011/0209457 A1
(43) Pub. Date: Sep. 1, 2011

(54) DEVICE FOR CORRECTING THE ALIGNMENT OF THE INTERNAL THREADS OF A CARTRIDGE BEARING FOR A CHAINSET

(76) Inventor: Dominique Crasset, La Cour Marigny (FR)

(21) Appl. No.: 13/122,736

(22) PCT Filed: Jul. 24, 2009
(86) PCT No.: PCT/FR09/00923

§ 371 Date: May 9, 2011

(30) Foreign Application Priority Data
Oct. 24, 2008 (FR) 0805935

(51) Int. Cl. B21L 9/00; B23P 11/00

(52) U.S. Cl. 59/5; 29/428

(57) ABSTRACT

This invention relates to a device for correcting the alignment of the machining of a chainset housing (1b), the housing comprising a pair of half-casings (2a, 2b) inserted in one of the openings of the housing (1b) to position the parts (3a, 3b) of a pedalling effort or chain tension sensor which pivots inside the casing (2) and positions the shaft of the chainset (4) so as to rotate eccentrically compared to the pivot axis (Y-Y′) of the sensor (3) inside the casing (2), said device being characterized in that the sensor enables pivoting of the half-casings via a rolling-contact bearing (5) which, in a cross section passing through the axes of the half-casings, allows a ball-joint-like turning of the pivot axis of the effort sensor (3) with respect to the axes of the half-casings in order to allow the pivot axis of the sensor to be positioned independently of the axes of the two half-casings so that errors of alignment between the axes of the two half-casings can be eliminated.

The present invention relates to the field of devices for correction of alignment of axes of inner threads of a chainset and more particularly to the field of devices for correction of alignment of inner threads of a chainset integrating an effort detector.

The patent FR 2 809 177 relates to a device associated with a pedalling or chain tension effort detector, the effort detector being positioned at the level of the chainset of a cyclist vehicle. Such an effort detector is connected to a self-regulating suspension to control and regulate the stiffness of the suspension by means of control means. According to one of its variant embodiments, the sensor is integrated into a chainset whereof the axis is arranged in the housing of a bearing. The sensor is formed by an eccentric which is in turn capable of executing pivoting relative to the frame of the cycle about an axis parallel to the axis of rotation of the chainset and coaxial with the latter. The axis of rotation of the chainset is also capable of pivoting about the pivot axis of the bearing such that when the axis of the chainset is positioned at the vertical of the pivot axis of the bearing, the sensor is sensitive to the tension of the chain and only slightly sensitive to the pedalling effort and when the axis of the chainset is arranged at the horizontal of the pivot axis of the bearing, the sensor becomes sensitive to the pedalling effort to the detriment of the effort on the chain tension.

When being made, such a sensor is mounted in a box for a chainset formed by a tubular transversal housing relative to the frame and of a substantially cylindrical form positioned in the frame of the cycle. This housing thus has an axis perpendicular to the planes of rotation of the cranks of the pedals mounted on either side of the chainset, and in which the bearing of the sensor which positions the chainset is mounted. Making this housing is generally a problem of rectilinear alignment of its axis during its drilling and inner threading. In fact, this housing is threaded by means of a tool which machines the housing at the level of the circular openings located on either side of the housing. The machining axes of these respective bores are generally offset from each other, either by being parallel but in different planes, or by forming an angle together.

Using a longer single tool to execute through-and-through machining is also a solution which, due to annealing, also causes offsetting of the bores.

This type of alignment problem of the axes is inconvenient for mounting and correct holding of a pivoting bearing with an effort detector according to patent FR 2 809 177, as this pivoting bearing is positioned in the housing due to two half-casings mounted and fixed on the openings on either side of the housing. Once mounted, these half-casings cannot correct offsetting of the axes of the housing.

The aim of the present invention is to rectify one or more disadvantages of the prior art and especially to propose a device for positioning an effort detector capable of avoiding the problem of offsetting during machining of the housing of the sensor.

This aim is attained by a device for correcting alignment of drilling and/or machining of a housing of a chainset arranged transversally to the frame of a cycle, the housing comprising a casing formed by a pair of substantially cylindrical tubular half-casings respectively inserted into one of the openings of the housing for positioning at least one element of a pedalling or chain tension effort detector, the effort detector being inserted into the casing to pivot inside the cylindrical part of at least one half-casing, the effort detector having a substantially cylindrical tubular part in which the shaft of the chainset is positioned in dished rotation relative to the pivot axis (Y-Y′) of the sensor in the casing, the rotation of the sensor in the casing actuating pivoting of a pulley in a plane perpendicular to the pivot axis (Y-Y′) of the sensor, characterised in that articulation of the sensor with a half-casing is effected by means of a rolling bearing such that part of the radial face of the sensor forms the inner ring of the rolling bearing and the inner edge of the half-casing forms a swivelling surface which, in a cross-section passing through the axis of the half-casing, enables swivel movement of the pivot axis (Y-Y′) of the effort detector relative to the axis of the half-casing to correct positioning of the pivot axis (Y-Y′) of the effort detector relative to the axis of the half-casing and allow positioning of the pivot axis (Y-Y′) of the sensor independently of the axes of the two half-casings to avoid alignment errors between the axes of the two half-casings.

According to a variant embodiment, the device for correcting alignment of drilling and/or machining of a housing of a chainset according to the invention is characterised in that the rolling surface of the inner edge of a half-casing which forms the outer ring has a swivelling surface with a spherical form corresponding to a segment of a sphere whereof the centre belongs to the axis of the half-casing.

According to another variant embodiment, the device for correcting alignment of drilling and/or machining of a housing of a chainset according to the invention is characterised in that the effort detector comprises at least two half-elements which each comprise a first cylindrical tubular part and a second eccentric part which bears the radial face forming the inner ring of the rolling bearing, the two half-elements being fixed together by means of a fluted socket in which the cylindrical part of each of the half-elements is inserted, each of the half-elements articulating with a respective half-casing.

According to another variant embodiment, the device for correcting alignment of drilling and/or machining of a housing of a chainset according to the invention is characterised in that the rolling elements of the rolling bearing have a substantially cylindrical structure with a radial surface curved in a barrel shape for each rolling body, where the curving of the radial surface of each rolling body is substantially parallel to the swivelling surface of the inner edge of the half-casing against which it articulates, in a cross-section passing through the axis of the half-casing.

According to another variant embodiment, the device for correcting alignment of drilling and/or machining of a housing of a chainset according to the invention is characterised in that since the rolling elements are balls, the rolling elements articulate with a swivelling surface of the half-casing by means of a swivel ring arranged between the rolling elements and the rolling surface of the half-casing, this swivel ring comprising an inner edge which bears a track for the rolling elements of the rolling bearing and an outer surface substantially rounded in a plane passing through the axis of the half-casing and/or the pivot axis (Y-Y′) of the sensor, such that the outer surface of the swivel ring is parallel to the swivelling surface of the half-casing against which it articulates.

According to another variant embodiment, the device for correcting alignment of drilling and/or machining of a housing of a chainset according to the invention is characterised in that the rolling elements of the rolling bearing are formed by at least two assemblies of balls in displacement in tracks of rolling bearing respective parallel to each other and arranged on the radial face of the sensor.

According to another variant embodiment, the device for correcting alignment of drilling and/or machining of a housing of a chainset according to the invention is characterised in that the means which articulates to allow swivelling with the swivelling surface of the half-casing is held in position in the swivelling surface by a closing ring which laterally partitions the swivelling surface to form blocking or a stop.

According to another variant embodiment, the device for correcting alignment of drilling and/or machining of a housing of a chainset according to the invention is characterised in that a dust-protection cover is fixed at each end of the sensor to laterally block the rolling bearing between the half-casing and the sensor, and in that the periphery of the dust-protection cover in contact with the swivelling surface of the half-casing which forms the outer ring comprises a tongue with a profile corresponding to a segment of a sphere whereof the centre belongs to the axis of the half-casing and/or to the pivot axis (Y-Y′) of the sensor.

According to another variant embodiment, the device for correcting alignment of drilling and/or machining of a housing of a chainset according to the invention is characterised in that a dust-protection cover is fixed at each end of the sensor to laterally block the rolling bearing between the half-casing and the sensor, and in that the periphery of the dust-protection cover comprises a tongue in contact with the inner edge of the closing ring, the tongue and the inner edge of the closing ring comprising a profile corresponding to a segment of a sphere whereof the centre belongs to the axis of the half-casing and/or to the pivot axis (Y-Y′) of the sensor.

According to another variant embodiment, the device for correcting alignment of drilling and/or machining of a housing of a chainset according to the invention is characterised in that at least one articulation between the sensor and a half-casing is positioned outside the housing of the chainset.

Another aim of the invention is to propose a method for mounting the alignment correction device of the invention.

This aim is attained by a process for mounting the device for correcting alignment of drilling and/or machining of a housing of a chainset according to the invention, the process comprising:
a step for mounting of the casing on the chainset by inserting it into the housing,
a step for positioning of the effort detector in the casing,
a step for positioning of the shaft of the chainset in the sensor, characterised in that
   the step for positioning of the effort detector in the casing comprises:
a step for inserting a first element of the sensor at one end of the casing,
a step for mounting of the rolling bearing which articulates the first element of the sensor with the casing,
a step of swivelling of the rolling bearing which articulates the first element of the sensor with the casing to enable coaxial fixing according to the pivot axis (Y-Y′) of the sensor of the first element of the sensor with a second element of the sensor inserted at another end of the casing.

The invention, with its characteristics and advantages, will become clearer from understanding of the description given in reference to the attached diagrams, in which:

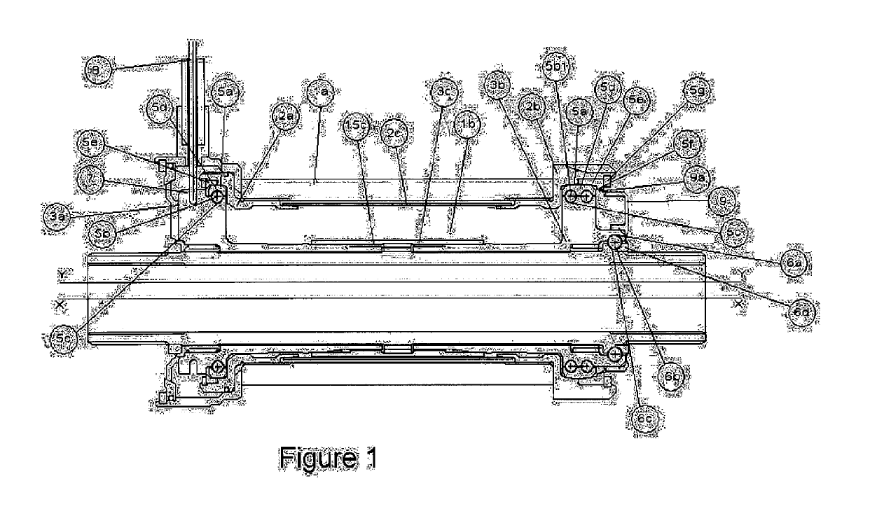

FIG. 1 schematically illustrates a first variant embodiment of the correction device of the invention according to a section through a plane passing through the respective pivoting axes of the chainset and of the effort detector,

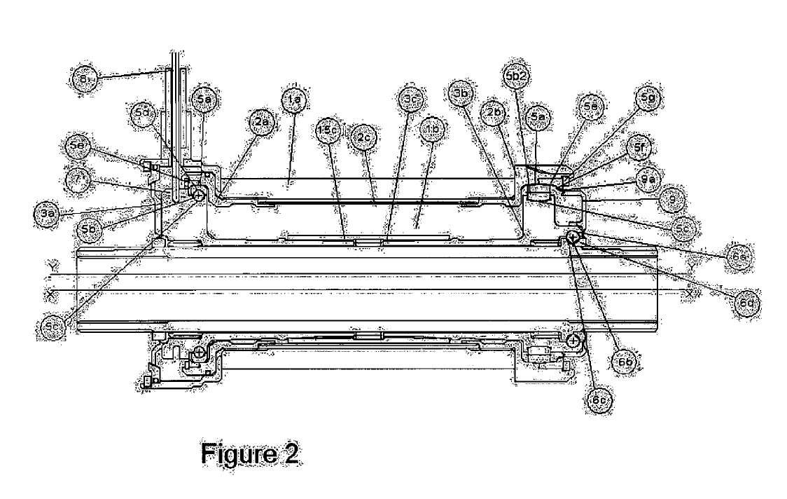

FIG. 2 schematically illustrates a second variant embodiment of the correction device of the invention according to a section through a plane passing through the respective pivoting axes of the chainset and of the effort detector,

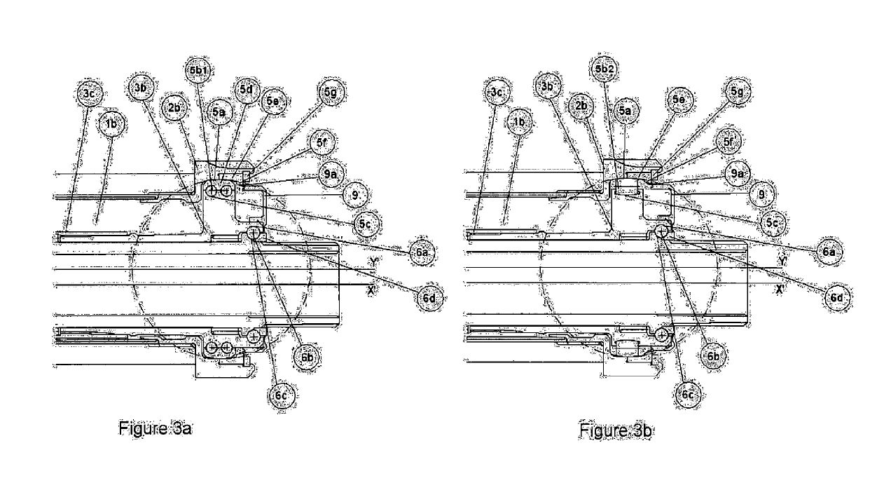

FIGS. 3a and 3b illustrate respectively detailed views of the variants of FIGS. 1 and 2 of the correction device of the invention.

The device of the invention avoids alignment errors of the axes of the openings located on either side of the box which forms the housing (1b) of the chainset of the frame (1a) of a cycle. This housing (1b) has the form of a cylindrical tubular conduit of standard length according to known standards. A casing (2), preferably formed by a pair of half-casing (2a, 2b), is inserted in this housing (1b). Each of these half-casings is mounted on one of the two openings of the housing (1b) of the chainset. These two half-casings have a first tubular cylindrical part inserted into the housing (1b) of the chainset at the level of an opening and a second part which is kept outside the housing against the opening of the housing (1b). The two half-casings are connected together at the level of their respective cylindrical part by means of a cylindrical protective piece (2c) arranged inside the housing (1b) of the chainset. Insertion of the casing (2) in the housing (1a) of the chainset is done, for example by screwing, such that each half-casing is in contact with the inner wall of the housing (1) of the chainset.

Positioned in the tubular conduit formed by the assembly made by the two joined half-casings is a chain tension effort and pedalling effort sensor (2) operating according to the principle described in one of the variants of the device disclosed in patent FR 2 809 177. This effort sensor (2) is arranged according to an axis substantially parallel to the axis of the housing (1a) of the chainset. This sensor (2) especially has the form of a tubular conduit in which is positioned according to a substantially parallel axis the shaft of the chainset (4) at the end of which are positioned the two cranks which bear the pedals of the cycle and one or more plates which drive the chain.

According to a particular embodiment, the chain tension effort and pedalling effort sensor (2) is made from a pair of eccentric half-elements (3a, 3b) with a cylindrical part which forms a tubular conduit for receiving the chainset (4) and an eccentric part whereof the periphery articulates with the casing (2). The two eccentric half-elements (3a, 3b) are respectively inserted on either side of the tubular conduit of the casing (2) and joined by their cylindrical part by means of a socket (3c), for example fluted, to enable linking in rotation of the half-elements of the sensor (3). The effort sensor (3) articulates with the casing (2) by at least one rolling bearing (5) which enables rotation of the sensor (2) about an axis (Y-Y′). The shaft of the chainset (4) articulates with the sensor (2) by means of at least one rolling bearing which enables rotation of the chainset (4) about an axis (X-X′) non coaxial with this axis of rotation (Y-Y′) to allow the sensor (2) to function. One of the half-elements (3a) of the sensor (3) bears a pulley (7) arranged in a plane substantially perpendicular to the axis (Y-Y′) of the sensor (3), this pulley (7) able to be centred or off-centred relative to the axis of rotation (Y-Y′) of the sensor (3). Fixed to this pulley (7) is the end of a cable (8) mounted in a sleeve, the pivoting of the sensor (3) about its axis (Y-Y′) causing rotation of the pulley (7) and traction or relaxing of tension on the cable (8). The end of the cable (8) can be fixed to the pulley, for example, by means of a crimping lead.

The rolling bearings which form the articulations between the shaft of the chainset (4) and the sensor (2) are made such that the radial surface of the chainset forms the inner ring of the rolling bearing by bearing a rolling track (6c). Opposite, the inner face of the sensor (2) forms the outer ring of the rolling bearing by also bearing a rolling track (6a) such that an assembly of rolling elements (6b) are mobile between the tracks respectively carried by the sensor (2) and the chainset (4). Making this rolling bearing can especially require a closing ring (6d) of the rolling bearing, mounted for example about the axis of the chainset (4), against its rolling track (6a). A number of rolling bearings can be used between the sensor (3) and the shaft of the chainset (4). Preferably, these rolling bearings are positioned at the ends of the shaft of the chainset and in the central part of the shaft of the chainset (4) between the chainset (4) and the socket (3c). Due to space restrictions, the rolling elements used are needles. According to a preferred embodiment, these needles move in rolling bearings whereof the respective outer ring is formed by a throat on the inner face of the cylindrical part of the sensor (3). The depth of the throats is substantially identical to the diameter of the needle rolling bearing. These throats are closed by the radial surface of the shaft of the chainset (4) inserted into the tubular conduit of the sensor (3). At the level of the end of the shaft of the chainset (4) which bears the plates and the chain of the cycle, the rolling bearings are preferably reinforced by being doubled, or even tripled. According to a particular embodiment, doubling of the rolling bearing at the end of the shaft of the chainset (4) which bears the chain and the plates is done by coupling a ball roller bearing and a needle roller bearing.

Articulation between the sensor (3) and the casing (2) is permitted by a rolling bearing between the inner face of the tubular part of the casing (2) and a portion of the radial face of the sensor (3). The rolling bearing comprises an inner ring formed by a throat (5c) supported by the radial face of the sensor (3). This throat (5c) is preferably positioned at the periphery of the off-centred part of the half-element of the sensor (3) and forms the inner ring of the rolling bearing. This off-centred part has the form of a disc positioned in a plane substantially perpendicular to the axis of the cylindrical tubular part of the half-element of the sensor (3). This disc is off-centred relative to the axis (X-X′) of the cylindrical tubular part of the half-element of the sensor (3) which positions the shaft of the chainset (4). The throat (5c) of the periphery of the off-centred part is positioned opposite a swivelling surface (5a) supported by the inner surface of the casing (2).

The swivelling surface (5a) has a sufficiently wide surface to allow displacement of the rolling elements (5b2) or of the lateral surface of a swivel ring (5d) in a plane passing through the axis of rotation (Y-Y′) of the rolling bearing and perpendicular to the plane of the rolling bearing. The aim of this particular displacement of the rolling elements (5b2) and/or of the lateral surface of a swivel ring (5d) is to enable swivel movement for the rolling bearing (5) and for the cylindrical part of the sensor (3). According to a preferred embodiment, the swivelling surface (5a) forms a substantially spherical ring which is inscribed in a sphere whereof the centre is positioned on the axis of rotation of the rolling bearing, that is, the axis of rotation (Y-Y′) of the sensor (3). So, in a cross-section of the rolling bearing according to a plane which passes through the axis of the half-casing and/or the axis of rotation of the sensor, the swivelling surface (5a) supported by the outer ring has a circular form which corresponds to a circle whereof the centre belongs to the axis of rotation of the rolling bearing. The assembly of the swivelling surface (5a) forms the surface of a segment of a sphere centred on the axis of rotation (Y-Y′) of the sensor.

The rolling elements (5b) in movement in the rolling bearing (5) are made so as to enable displacement which generates swivel movement of the sensor during its rotation about its pivot axis (Y-Y1).

According to a first particular embodiment, the rolling elements (5b2) are formed by elements which have a substantially cylindrical structure whereof the radial surface is curved, giving each rolling body (5b2) the appearance of a barrel. It should be noted that the curving of these rolling elements (5b) is done such that the radial surface of each rolling body (5b) in contact with the swivelling surface (5a) supported by the inner face of the half-casing (2a, 2b), has a profile substantially parallel to that of the swivelling surface (5a) in a plane passing through the axis of rotation of the rolling bearing (5). The swivelling surface (5a) forms a rolling track for the rolling elements (5b2) of the rolling bearing. The inner surface of the half-casing forms the outer ring of the rolling bearing (5). The curving of the rolling elements (5b2) thus has a circular curve according to an arc of a circle whereof the radius is substantially identical to the distance separating the rolling surface supported by the half-casing and the axis of rotation of the sensor (3). A device with curved rolling elements (5b2) avoids using a swivel ring (5d).

In fact, according to a second particular embodiment, the rolling elements (5b1) are made by balls. These balls (5b1) are not positioned directly in contact with the rolling surface supported by the half-casing (2a, 2b), but interact with this surface by means of a swivel ring (5d). This swivel ring (5d) is a ring arranged between the half-casing (2a, 2b) and the rolling elements (5b1) of the rolling bearing (5). The inner wall of this swivel ring (5d) forms a rolling track for the rolling elements (5b1). This swivel ring (5d) also forms the outer ring of the rolling bearing (5). The outer surface of this swivel ring (5d) articulates with the swivelling surface supported by the half-casing (2a, 2b). The outer surface of the swivel ring (5d) forms a segment of a sphere whereof the radius is substantially identical to the distance separating the rolling surface supported by the half-casing and the axis of rotation of the sensor (3) and centred on the axis of rotation of the sensor (3).

According to a particular feature of embodiment, the rolling bearing (5) comprises several sets of balls (5b1) in displacement in respective rolling bearing tracks arranged parallel to each other on the radial face of the sensor. This plurality of sets of balls (5b1) allows greater resistance to stresses borne by articulation. When the device of the invention comprises a swivel ring (5d), the latter bears on its inner face several throats, each of the throats corresponding to a set of balls (5b1) of the rolling bearing, therefore whatever the number of sets of balls (5b1) in the rolling bearing, the articulation with the inner face of the half-casing which allows swivel movement requires only one swivelling surface with the half-casing (2a, 2b).

For easy positioning of the rolling elements (5b2) in the rolling bearing and/or insertion of the rolling elements (5b1) mounted on a swivel ring (5d), and for holding the rolling elements (5b2) and/or the swivel ring (5d) on the swivelling surface (5a) of the inner face of the casing (2), a closing ring (5e) can for example laterally partition the swivelling surface (5a) of the half-casing by forming blocking or a stop (5f). According to a particular embodiment, this closing ring (5e) is made by a ring whereof the inner diameter is less than the diameter of the swivelling surface (5a) of the rolling bearing (5) such that the rolling elements (5b2) remain held in the space between the two rings of the rolling bearing (5). This closing ring (5e) can also be held in position against the lateral wall of the rolling bearing by a fixing clip (5g).

According to a preferred embodiment, each of the ends of the sensor comprises a dust-protection cover (9), traversed by the shaft of the chainset (4), which laterally blocks the rolling bearing between the half-casing and the sensor. The periphery of the dust-protection cover comprises a tongue (9a) arranged to be held in contact with the lateral edge of the rolling surface (5a) of the half-casing (2a, 2b), or with the inner edge of the closing ring (5e). According to a preferred embodiment, the tongue of the dust-protection cover has a profile of a segment of a sphere centred on the pivot axis (Y-Y′) of the sensor (3). This profile has a circular shape which, in a cross-section passing through the pivot axis (Y-Y′) of the sensor (3), corresponds to a circle whereof the centre belongs to the pivot axis (Y-Y′) of the sensor (3) such that the tongue is adapted to the swivelling surface (5a) of the half-casing (2a, 2b). When the tongue (9a) of the dust-protection cover is positioned against the inner edge of the closing ring (5e), the inner edge of the closing ring (5e) also has a surface which corresponds to a segment of a sphere centred on the pivot axis (Y-Y′) of the sensor (3).

Because the width of the frame (1a) and the diameter of the housing of the chainset (1b) are defined according to known standards, the positioning of the articulations between the casing (2) and the sensor (3) may need to be done outside the housing, that is, for example on either side of the chainset (1b). This positioning of articulations outside the housing of the chainset (1b) gives greater solidity and rigidity relative to a similar device integrated inside the housing of the chainset (1b). On each side of the chainset (1b), the half-casings have a structure with enlarged diameter which allows insertion of the off-centred part of the half-element of the sensor (3). This off-centred part forms a disc which bears on its periphery the rolling track (5c) of the inner ring of the rolling bearing (5). It is important that the articulations on either side of the chainset (1b) are not too wide to prevent the spreading of the pedal cranks mounted at the ends of the shaft from being uncomfortable for the cyclist.

During mounting of the sensor according to the invention, the half-casings are inserted into the housing of the chainset (1b) and connected by a cylindrical protective piece (2c). The half-elements (3a, 3b) of the sensor (3) are then inserted into the casing (2) and also connected by a socket (3c). The rolling elements (5b) carried by the sensor (3) are then inserted into the rolling bearing (5) which forms the articulation between the casing (2) and the sensor (3). The rolling elements (5b) can be inserted by attaching them to a swivel ring (5d). The rolling bearings are then closed by positioning of a closing ring (5e) held in place by a clip element (5f). However, the half-elements (3a, 3b) of the sensor are mounted by mounting a first half-element and its rolling bearing (5), then mounting the second half-element by placing the second rolling bearing at play on the swivelling to enable coaxial alignment of the two half-elements (3a, 3b) of the sensor (3). Once the sensor is positioned, the shaft of the chainset (4) is then inserted into the tubular part of the sensor (3) according to a known process.

According to a variant embodiment of mounting, at least one of the articulations between a half-casing and a corresponding half-element (3a, 3b) of the sensor (3) is mounted prior to being inserted into one of the orifices of the housing of the chainset (1b). Once this articulation is inserted into the housing of the case of the chainset (1b), the second half-casing and the corresponding half-element (3a, 3b) are positioned in the housing of the case of the chainset (1b). This second articulation can also be mounted prior to being inserted into the second orifice of the chainset (1b), or else simultaneously by positioning via successive insertion of the second half-casing and of the second half-element.

It must be evident for experts that the present invention allows embodiments in numerous other specific forms without departing from the field of application of the invention as claimed. Consequently, the present embodiments must be considered by way of illustration but can be modified in the field defined by the scope of the attached claims.

1. A device for correcting the alignment of drilling and/or machining of a housing of a chainset arranged transversally to the frame of a cycle, the housing comprising a casing formed by a pair of substantially cylindrical tubular half-casings inserted respectively into one of the openings of the housing to position at least one element of a pedalling effort or chain tension effort sensor, the effort sensor being inserted into the casing to pivot inside the cylindrical part of at least one half-casing, the effort sensor having a substantially cylindrical tubular part in which is positioned the shaft of the chainset in dished rotation relative to the pivot axis of the sensor in the casing, the rotation of the sensor in the casing actuating pivoting of a pulley in a plane perpendicular to the pivot axis of the sensor, wherein the articulation of the sensor with a half-casing is effected by means of a rolling bearing such that part of the radial face of the sensor forms the inner ring of the rolling bearing and the inner edge of the half-casing forms a swivelling surface which, in a cross-section passing through the axis of the half-casing, enables swivel movement of the pivot axis of the effort sensor relative to the axis of the half-casing to correct the positioning of the pivot axis of the effort sensor relative to the axis of the half-casing and en-able-enables positioning of the pivot axis of the sensor independently of the axes of the two half-casings to avoid alignment errors between the axes of the two half-casings.

2. The device for correcting the alignment of drilling and/or machining of a housing of a chainset as claimed in claim 1, wherein the rolling surface of the inner edge of a half-casing which forms the outer ring has a swivelling surface with a spherical form corresponding to a segment of a sphere whereof the centre belongs to the axis of the half-casing.

3. The device for correcting the alignment of drilling and/or machining of a housing of a chainset as claimed in claim 1, wherein the effort sensor comprises at least two half-elements which each comprise a first tubular cylindrical part and a second eccentric part which bears the radial face forming the inner ring of the rolling bearing, the two half-elements being joined together by means of a socket in which the cylindrical part of each of the half-elements is inserted, each of the half-elements articulating with a respective half-casing.

4. The device for correcting the alignment of drilling and/or machining of a housing of a chainset as claimed in claim 1, wherein the rolling elements of the rolling bearing present a substantially cylindrical structure with a radial surface curved in a barrel shape for each rolling body, the curving of the radial surface of each rolling body being substantially parallel to the swivelling surface of the inner edge of the half-casing against which it articulates, in a cross-section passing through the axis of the half-casing.

5. The device for correcting the alignment of drilling and/or machining of a housing of a chainset as claimed in claim 1, wherein since the rolling elements are balls, the rolling elements articulate with a rolling surface of the half-casing by means of a swivel ring arranged between the rolling elements and the swivelling surface of the half-casing, this swivel ring comprising an inner edge which bears a track for the rolling elements of the rolling bearing and an outer surface substantially rounded in a plane passing through the axis of the half-casing and/or the pivot axis of the sensor, such that the outer surface of the swivel ring is parallel to the swivelling surface of the half-casing against which it articulates.

6. The device for correcting the alignment of drilling and/or machining of a housing of a chainset as claimed in claim 1, wherein the rolling elements of the rolling bearing are formed by at least two sets of balls in displacement in respective rolling bearing tracks parallel to one another and arranged on the radial face of the sensor.

7. The device for correcting the alignment of drilling and/or machining of a housing of a chainset as claimed in claim 1, wherein the device which articulates to enable swivelling with the swivelling surface of the half-casing is held in position in the swivelling surface by a closing ring which laterally partitions the swivelling surface to form blocking or a stop.

8. The device for correcting the alignment of drilling and/or machining of a housing of a chainset as claimed in claim 2, wherein a dust-protection cover is fixed at each end of the sensor to laterally block the rolling bearing between the half-casing and the sensor, and in that the periphery of the dust-protection cover in contact with the swivelling surface of the half-casing which forms the outer ring comprises a tongue with a profile corresponding to a segment of a sphere whereof the centre belongs to the axis of the half-casing and/or to the pivot axis of the sensor.

9. The device for correcting the alignment of drilling and/or machining of a housing of a chainset as claimed in claim 7, wherein a dust-protection cover is fixed at each end of the sensor to laterally block the rolling bearing between the half-casing and the sensor, and in that the periphery of the dust-protection cover comprises a tongue in contact with the inner edge of the closing ring, the tongue and the inner edge of the closing ring comprising a profile corresponding to a segment of a sphere whereof the centre belongs to the axis of the half-casing and/or to the pivot axis of the sensor.

10. The device for correcting the alignment of drilling and/or machining of a housing of a chainset as claimed in claim 1, wherein at least one articulation between the sensor and a half-casing is positioned outside the housing of the chainset.

11. A process for installing a device for correcting alignment of drilling and/or machining of a housing of a chainset as claimed in claim 1, the process comprising:
a step for mounting of the casing on the chainset by inserting it into the housing,
a step for positioning of the effort sensor in the casing,
a step for positioning of the shaft of the chainset in the sensor, wherein the step for positioning of the effort sensor in the casing comprises:
a step for inserting a first element of the sensor at one end of the casing,
a step for mounting of the rolling bearing which articulates the first element of the sensor with the casing,
a step of swivelling of the rolling bearing which articulates the first element of the sensor with the casing to enable coaxial fixing according to the pivot axis of the sensor of the first element of the sensor with a second element of the sensor inserted at another end of the casing.
